(19) United States
(12) Patent Application Publication
(10) Pub. No.: US 2026/0005430 A1
(43) Pub. Date: Jan. 1, 2026

(54) FABRIC-BASED ANTENNAS FOR WIRELESS POWER WITHIN VEHICLE INTERIORS

(71) Applicant: Yank Technologies, Inc., Brooklyn, NY (US)

(72) Inventors: Milad MIRZAEE, Brooklyn, NY (US); Benjamin TEREBELO, Brooklyn, NY (US); Joshua Aaron YANKOWITZ, Brooklyn, NY (US)

(21) Appl. No.: 19/320,926

(22) Filed: Sep. 5, 2025

Related U.S. Application Data
(63) Continuation of application No. PCT/US2024/018939, filed on Mar. 7, 2024.
(60) Provisional application No. 63/488,820, filed on Mar. 7, 2023.

(51) Int. Cl. H01Q 1/32; H02J 50/40

(52) U.S. Cl. CPC H01Q 1/3208; H02J 50/40

(57) ABSTRACT

Fabric-based antennas for wireless power withing vehicle interiors are described. In some aspects, a vehicle interior product wireless power system comprises a transmitter electronic housing unit electrically connected to a wire harness of a vehicle. The system further comprises a first tuning and matching PCB electrically connected to the transmitter electronic housing unit, a transmitter antenna electrically connected to the first tuning and matching PCB, a receiver antenna for capturing flux from the transmitter antenna, a second tuning and matching PCB electrically connected to the receiver antenna, and a receiver electronic housing unit electrically connected to the second tuning and matching PCB. The receiver electronic housing unit may be electrically connected to loads or vehicle functions embedded into a vehicle interior product, such as a car seat, center console, or infotainment system.

### CROSS-REFERENCE TO RELATED APPLICATION

This application is a continuation and claims priority to International Application No. PCT/US2024/018939, filed on Mar. 7, 2024, which claims priority to U.S. Provisional Patent Application No. 63/488,820, filed on Mar. 7, 2023, the disclosure of which is hereby incorporated by reference herein in its entirety.

### TECHNICAL FIELD

The present document relates to wireless power transmission technology.

### BACKGROUND

Wireless power solutions can be a means of enabling new features for next-generation devices. However, traditional wire wound antennas cannot meet packaging and performance requirements of certain applications. The proposed fabric-based antennas for wireless power can meet thinner and greater durability requirements for certain applications.

### BRIEF SUMMARY

Techniques are disclosed for development and implementation of fabric-based antennas for wireless power applications for vehicle interiors. In this disclosure, the terms antennas and coils are used interchangeably.

In one example aspect, a vehicle interior product wireless power system comprises a transmitter electronic housing unit electrically connected to a wire harness of a vehicle. The system further comprises a first tuning and matching PCB electrically connected to the transmitter electronic housing unit. The system further comprises a transmitter antenna electrically connected to the first tuning and matching PCB. The system further comprises a receiver antenna for capturing flux from the transmitter antenna. The system further comprises a second tuning and matching PCB electrically connected to the receiver antenna. The system further comprises a receiver electronic housing unit electrically connected to the second tuning and matching PCB. The receiver electronic housing unit is electrically connected to loads or vehicle functions embedded into a vehicle interior product.

In some embodiments, at least one antenna comprises a fabric-based antenna, including a first support material layer, a second support material layer, and a base material layer disposed between the first support material layer and the second support material layer. The base material layer is a fabric-based conductor or conductive foil and less than several centimeters in thickness. One or more feedline wires are electrically connected to conductive material of the base material layer.

In some embodiments, the transmitter electronic housing unit comprises a switching amplifier, an impedance matching network, and/or one or more RF filters.

In some embodiments, the receiver electronic housing unit comprises an impedance matching network, an AC-DC converter and/or a DC-DC converter and/or a voltage regulation device that regulates output for the loads or the vehicle functions.

In some embodiments, the transmitter antenna and/or the receiver antenna comprise a fabric-based antenna for wireless power applications.

In some embodiments, multiple transmitter fabric-based antennas are configured to operate in a vehicle interior to focus flux on one or more areas of the vehicle rather than an entirety of the vehicle interior and/or for improved performance from the multiple transmitter fabric-based antennas as compared to a single transmitter fabric-based antenna.

These, and other, aspects are disclosed throughout the document.

### BRIEF DESCRIPTION OF THE DRAWINGS

FIG. 1 depicts an example fabric-based antenna wireless power system flow chart according to some embodiments of the disclosed technology.

FIG. 2 depicts an example wireless power vehicle interior product system according to some embodiments of the disclosed technology.

FIG. 3A and FIG. 3B depict a construction stackup with (a) separation material and (b) only support materials, respectively, according to some embodiments of the disclosed technology.

FIG. 4 depicts an example wireless power vehicle interior product system according to some embodiments of the disclosed technology.

FIG. 5A and FIG. 5B depict an example wireless power vehicle interior system according to some embodiments of the disclosed technology.

FIG. 6A and FIG. 6B depict an example wireless power vehicle interior system with fabric-based transmitters of different sizes according to some embodiments of the disclosed technology.

FIG. 7A and FIG. 7B depict an example wireless power vehicle interior system with (a) car seats in different positions and (b) a center console, respectively, according to some embodiments of the disclosed technology.

FIG. 8A and FIG. 8B depict an example wireless power vehicle interior system with (a) multiple tx antennas and (b) tx antennas driven by same electronics, respectively, according to some embodiments of the disclosed technology.

### DETAILED DESCRIPTION

Wireless power can be a means of enabling new features for next-generation vehicle interiors, such as interchangeable seat layouts, car seat rotation, and increased vehicle seat movement and actuation.

However, current transmitter antennas today can often struggle to meet thin packaging requirements (e.g., less than several centimeters) while meeting performance requirements. Some examples are vehicle floor interiors and wall panels. The proposed technology is the development and implementation of novel antennas for wireless power vehicle interior applications.

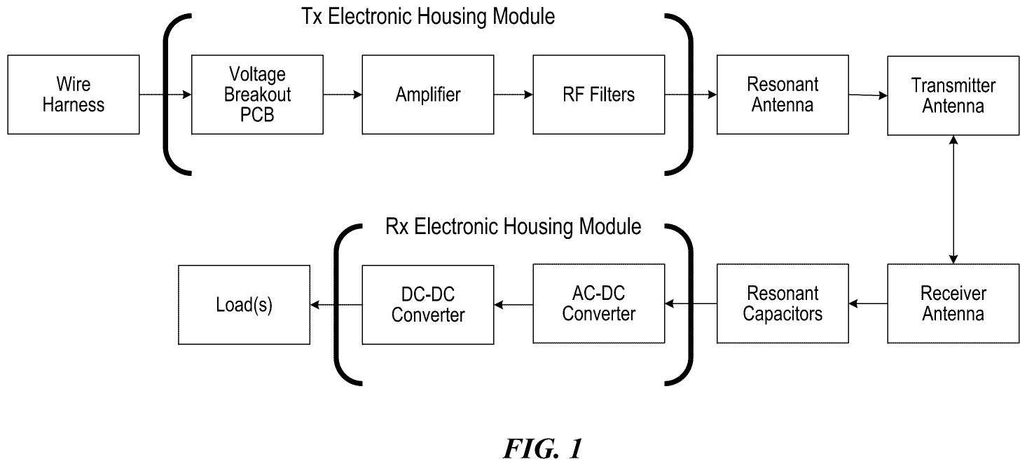

FIG. 1 depicts an example fabric-based antenna wireless power system flow chart. As shown in the example flow chart of the wireless power system in FIG. 1, the transmitter electronic housing is electrically connected to the wire harness of the vehicle, specifically the voltage breakout PCB. In this voltage breakout PCB, there is a step-down converter for the amplifier digital logic and a boost converter for the amplifier input. The step-down converter for the amplifier digital logic can be a buck, flyback, or sepic converter. Furthermore, the voltage breakout board can have reverse-polarity protection, EMI filters, fuse protection, and other forms of EMI, short circuit, and reverse-polarity protection circuitry.

The power amplifier can be a switching amplifier, such as a series or parallel resonant or off-resonant Class D or Class E amplifier. Additionally, the power amplifier can be single-ended or differential and can comprise an isolated switching amplifier topology. Furthermore, it can have a wideband impedance matching network or a parallel-tuned amplifier matching network topology. In a parallel-tuned resonant power amplifier, the load network and matching network are tuned such that the transmitter antenna is in parallel rather than in series to the resonant capacitor with the load network of the amplifier also tuned at the same resonant frequency. That is, the entire power amplifier network operates completely in resonance rather than using an off-resonant load network. This way, the voltage across the transmitter is maximized and harmonics are reduced. By maximizing the voltage, there is higher oscillating current flowing through the transmitter antenna or a stronger magnetic field to be coupled with the receiver, especially in a loose coupling resonant inductive system, such as when the transmitter and receiver are physically far apart. In some embodiments, a transformer can also be included to further increase the oscillating voltage across the transmitter antenna and thereby further improve the flux linkage and power delivery between the transmitter and receiver. Additionally, the parallel resonant power amplifier is better protected from movements or changes in the position of the receiver or capacitive and inductive reflections from the surrounding environment that could cause a substantial change in the efficiency of the power amplifier. Further details may be found in commonly owned PCT Patent Application Publication No. WO2021/178821, entitled “AUTOMOTIVE CAR SEAT WIRELESS CHARGING SYSTEM,” which is incorporated by reference herein. Additionally, further details may be found in commonly owned PCT Patent Application Publication No. WO2020/069198, entitled “PARALLEL TUNED AMPLIFIERS,” which is incorporated by reference herein.

The amplifier can then be electrically coupled to RF filters, such as bandpass filters, to attenuate undesirable harmonics and spurious signals. The signal then couples with antenna(s) tuned with resonant capacitors and matched to the optimal impedance of the system. These capacitive and potentially inductive parts for tuning and matching can be consolidated into the electronics housing unit directly or into a separate transmitter antenna matching and tuning PCB physically closer to the antenna to reduce the feedline wire length between the antenna and its corresponding resonant capacitors.

The receiver antenna(s) are excited with capacitors to substantially resonate, match to the impedance of the receiver electronics, and capture the flux from the transmitter antenna(s). This signal is then electrically connected to an AC-DC converter and/or a DC-DC converter and/or a voltage regulation device for various voltage levels depending on the application, but typically 12V to 16V for vehicle interior applications.

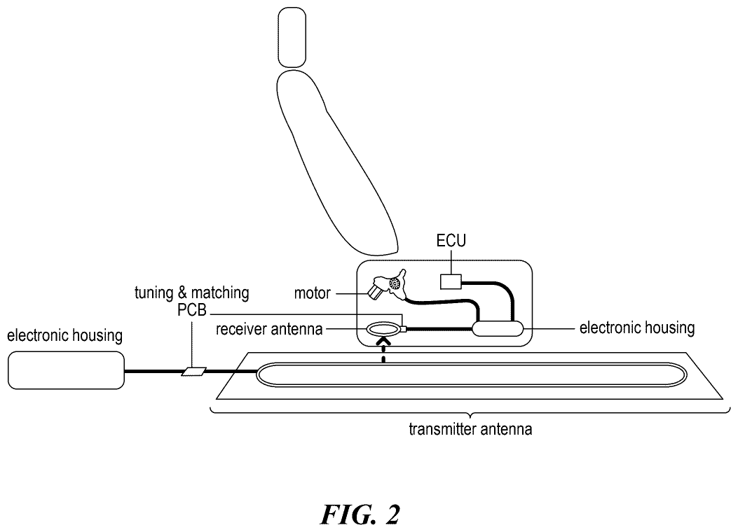

FIG. 2 depicts an example wireless power vehicle interior product system. For example, FIG. 2 illustrates an example vehicle seat wireless power system that incorporates the FIG. 1 flow chart. In this example embodiment, the transmitter electronic housing unit is electrically connected to the wire harness of the vehicle and consists of the voltage breakout PCB, switching amplifier, impedance matching network, and RF filters. Furthermore, some or all of the features described in the transmitter electronic housing can be incorporated into a single consolidated or separated PCBs within the transmitter electronic housing module. In addition, the transmitter electronic housing module can be partitioned into a single or several electronic housing modules for easier assembly if applicable.

The output of the transmitter electronics is electrically connected to a tuning and matching PCB, which substantially excites the transmitter at the optimal resonant frequency (e.g., 85 kHz, 100 kHz, 6.78 MHz, 13.56 MHz, and 27.1 MHz).

The receiver antenna is then substantially excited and matched by a corresponding tuning and matching PCB, which is electrically connected to the receiver electronic housing. In the receiver electronics, there is an AC-DC converter and/or a DC-DC converter and/or a voltage regulation device that regulates the output for the vehicle functions. Similar to the transmitter electronic housing unit, the receiver electronic housing can be incorporated into a single consolidated or separated PCBs within the receiver electronic housing module. In addition, the receiver electronic housing module can be partitioned into a single or several electronic housing modules for easier assembly if applicable. Furthermore, the tuning and matching components can also be consolidated into the receiver electronic housing.

The receiver electronic housing is electrically connected to the loads or vehicle functions embedded into the car seat, center console, or other vehicle interior appliance. In the FIG. 2 example, there are motor and electronic control unit (ECU) functions embedded into the seat as the loads for the wireless power system. Other features can be SVS fans, heaters, multiple actuators, and speakers.

The transmitter and receiver antenna(s) can be fabric-based antennas for wireless power applications to meet packaging and performance requirements. In some embodiments, these novel antennas have a base material, a first support material, and a second support material. In other embodiments, there is a support material, a separation material, a base material, a second separation material, and a second support material.

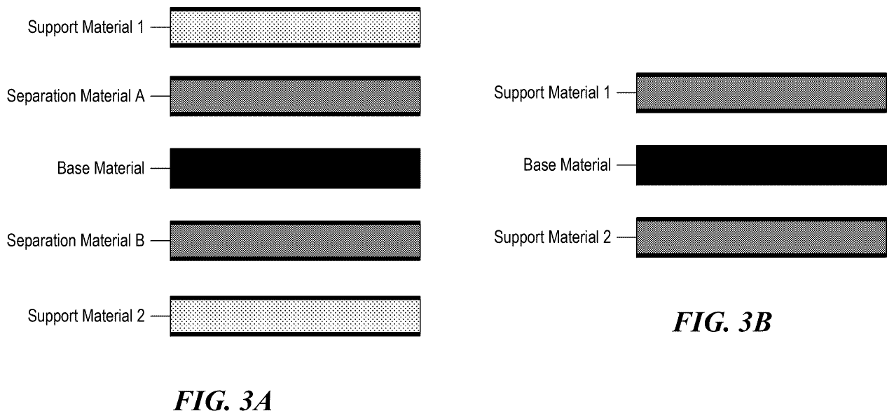

FIG. 3A and FIG. 3B depict a construction stackup with (a) separation material and (b) only support materials, respectively. As shown in FIG. 3A, the separation material A and the separation material B are selected for a low dielectric constant and dissipation factor for optimal performance. Some example support materials are felt, denim, pellon, and polyester. In some embodiments, the low dissipation factor may include values less than 0.02 or another suitable value. In some embodiments, the low dielectric constant may include values less than 4 or another suitable value. The dissipation factor and/or the dielectric constant may vary based on test frequency and material type. In some embodiments, the support material can be the separation material if the materials meet the durability, environmental, mechanical, and/or other system requirements of the application, which is illustrated in the stackup in FIG. 3B. In the event that the separation materials cannot meet these requirements, support materials can be selected, such as plastics. The separation material A and the separation material B can be the same or distinct. Similarly, the support material 1 and the support material 2 can be the same or distinct.

The base material is often a fabric-based conductor or conductive foil with low resistance. For wireless power transfer, developing high intrinsic quality (‘Q’) antennas may be an important design criterion to improve system efficiency, charging distance, and power delivered to the load. Intrinsic quality is the measure of inductive reactance over resistance. In other words, it is a measure of the energy stored over the energy dissipated for the antenna. It is a dimensionless parameter that is typically used as a barometer for antenna efficiency. The higher the ‘Q’ of the transmitter and receiver antennas, the better they will couple with one another. Therefore, the higher conductivity, the better the base solution for wireless power transfer applications. Some example materials are copper foil, tin-plated copper foil, aluminum foil, aluminum polyester foil, copper polyester taffeta fabric, ripstop silver fabric, and Ni/Cu/Ag plated polyamide fabric. Furthermore, the base material can be less than several millimeters in thickness.

The base material design can be manufactured by press cutting, automatic blade cutting, laser cutting, and water jet cutting. In order to develop a robust structure, the base material can be sandwiched between two layers of separation material. In this instance, the separation materials are directly touching the base material on both sides. The layers can be bonded to the stabilizer by using one of or a combination of the following methods: sewing, adhesives, and fusing.

Furthermore, there can be a tuning and matching PCB embedded into the separation material A or B and electrically connected to the feedlines of the antenna. On the Tuning and Matching PCB, capacitors can be placed to substantially excite the antenna at the optimal resonant frequency of the application (e.g., 85 kHz, 100 kHz, 6.78 MHz, 13.56 MHz, and 27.1 MHz). This can be in series, parallel, series-parallel, and parallel-series configurations. Furthermore, an impedance matching network can be implemented to optimize the impedance match between the antenna and the amplifier that drives it in the transmitter or the converter that is electrically connected in the receiver. The impedance matching network can consist of passive components, such as inductors, capacitors, and resistors. Some example impedance values may be 5, 10, 15, and 50 ohms.

Furthermore, the Tuning and Matching PCB can also have a mechanical clasp or support structure to better guard and preserve the structural integrity of the PCB. The PCB support structure can be a durable plastic or metal, such as ABS, polycarbonate, PLA, and polypropylene. The purpose of this can be further underscored when it is possible that a person or entity can interact physically with the device. For example, if the antenna is embedded into a car seat or floor of a vehicle, a passenger may be able to physically step on the PCB. Another example can be an automated vehicle, such as an automated guided vehicle, accidentally contacting the antenna on a wall or floor of a factory or fulfillment center.

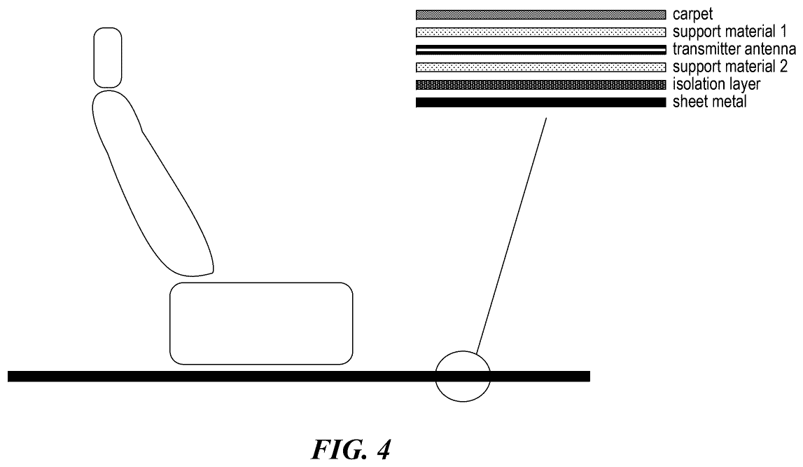

FIG. 4 depicts an example wireless power vehicle interior product system. In particular, FIG. 4 illustrates the modified stackup for a vehicle interior application. In this example embodiment, the carpet of the vehicle is on top of the support material 1. However, like previously described stackups, separation materials can be placed between the base material and the support materials that have a low dielectric constant and dissipation factor for optimal performance.

In the floor of a vehicle, there is typically an isolation layer or foam-like layer that separates the carpet from the metal body. For the installation of the fabric-based transmitter antenna, the isolation layer can be present in lieu of a separation material or a separation material can be placed between the support material 2 and the isolation layer. This is an important design decision because the metal body of the vehicle will de-Q or reduce the intrinsic Q of the transmitter antenna, so an optimal distance between the transmitter antenna and the metal body of the vehicle should be maintained. For example, the base material layer can typically be several millimeters or greater from the metal floor of the vehicle.

Furthermore, due to the close proximity of the metal floor of the vehicle to the antenna, a ferromagnetic material can also be placed between the support material 2 and the isolation layer or between the isolation layer and the sheet metal. This material can be high permeability, low loss material, such as a ferrite sheet. In some embodiments, the high permeability may include values such as 50, 100, 200, or another suitable value (μ′) at the operating frequency of the system, while low loss (μ″) in the material may include values such as 1, 2, 5, 10, 20, or another suitable value. For example, the material selected may represent the highest permeability and lowest loss possible from the available options.

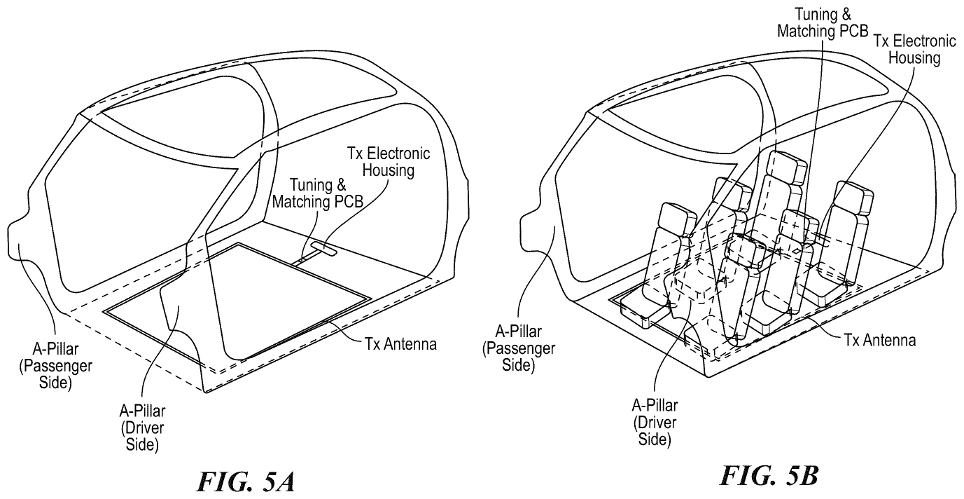

FIG. 5A and FIG. 5B depict an example wireless power vehicle interior system. A single transmitter fabric-based antenna can power one or many receivers in the vehicle interior. FIG. 5A and FIG. 5B illustrate multiple car seats throughout the interior cabin that is powered from the same transmitter fabric-based antenna. While FIG. 5A and FIG. 5B refer to only car seats, it is important to note that the wireless power vehicle interior system can also power other types of vehicle products, such as center consoles and infotainment systems.

The wireless power vehicle interior system enables reconfigurable interior layouts in real-time, an aspect especially important for autonomous vehicles, because the receivers can significantly couple with the transmitter fabric-based antenna while the orientation and position of the vehicle products change and move for next-generation vehicles. For example, multiple car seats can be powered reliably while they move and rotate simultaneously, which can add further convenience to passengers. Furthermore, interchangeable vehicle interiors can also add benefits to delivery businesses, especially autonomous ones, so that they can drop off passengers for one route and then have the seats rotate forward and stow for making room to pick up and store packages for another route.

Interchangeable vehicle interiors are very arduous to do with traditional wire harness connections because the seats would require expensive and unreliable clocksprings and mechanical connections for the complex movement and rotation. These complex harnesses would in turn present a large warranty expense for the Original Equipment Manufacturers (OEMs) of these vehicles and the Tier 1 suppliers of these vehicle products.

For current vehicles, this wireless power system also allows for more reliable car seats that require long-rail seat movement, such as a meter or more track length. This is because long-rail seat movement (e.g., for vans) today requires complex wire harnesses and clocksprings that mechanically spool and unspool the wire harness, which become unreliable and are prone to break and tear over time.

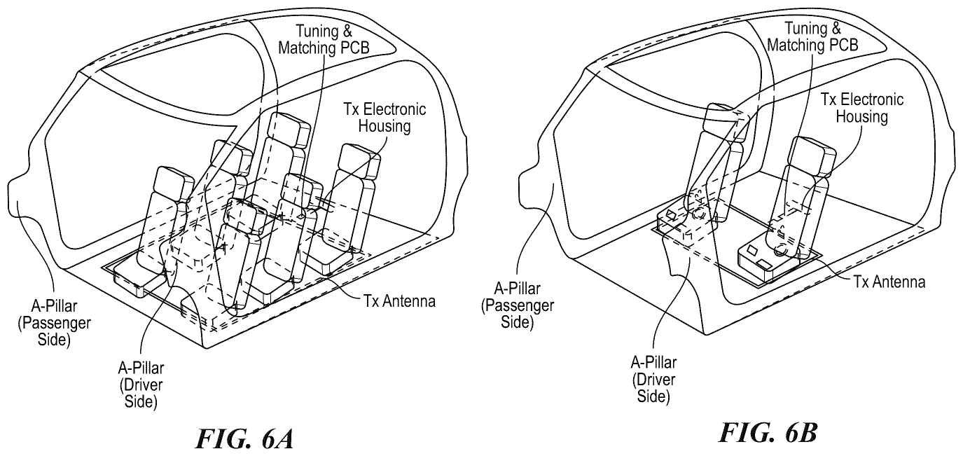

Furthermore, the number of receivers, such as seats, and the placement of those receiver devices in the vehicle can be altered depending on the desired interior application. This in turn means that the length and width of the transmitter antenna may increase or decrease depending on the area of coverage necessary for the application. For example, in some embodiments, it may be desirable to power only middle row seats that have long-rail distance travel. FIG. 6A and FIG. 6B depict an example wireless power vehicle interior system with fabric-based transmitters of different sizes. FIG. 6A and FIG. 6B illustrate how in this instance the length and width of the transmitter antenna can change based on the desired application.

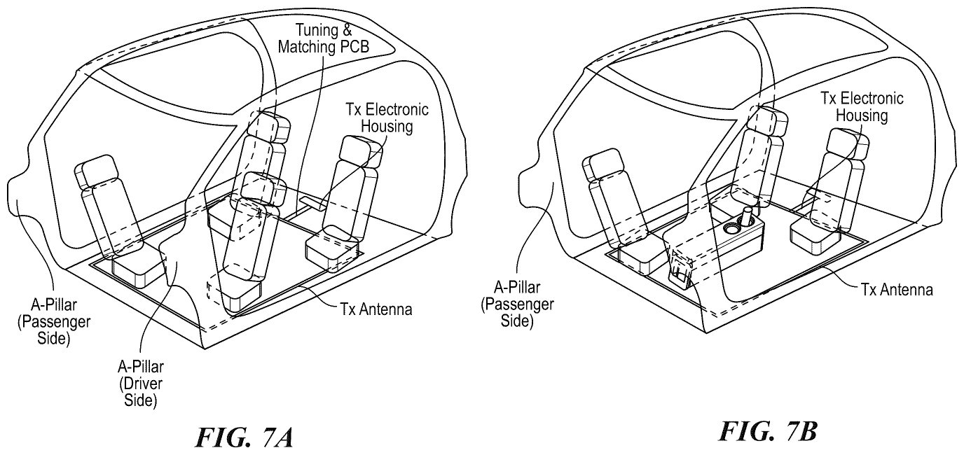

In other embodiments, it may simply be desirable to have the entire interior cabin reconfigurable and seats, center consoles, infotainment systems, and other vehicle interior products completely interchangeable and readily moveable to different areas. FIG. 7A and FIG. 7B depict an example wireless power vehicle interior system with (a) car seats in different positions and (b) a center console, respectively. FIG. 7A and FIG. 7B illustrate that the orientation, position, and vehicle devices can be modified by implementing this wireless power vehicle interior system.

The receiver antenna(s) can also be fabric-based antennas but may also be several other antenna types. For example, a receiver antenna can be planar antennas, electrodeposited antennas formed directly onto a vehicle part (e.g., onto Class A and Class B vehicle surfaces), or three-dimensional antennas. A three-dimensional antenna can be particularly useful for improving the coupling between the receiver(s) and the transmitter(s). Further details may be found in commonly owned PCT Patent Application Publication No. WO2020/069198, entitled “PARALLEL TUNED AMPLIFIERS,” which is incorporated by reference herein.

A three-dimensional antenna is a surface spiral coil comprising a continuous conductor with no breaks wherein the three-dimensional antenna comprises a surface spiral coil comprising a continuous conductor with no breaks or radio frequency discontinuities wound around a dielectric material at an angle to diminish a proximity effect at an operating frequency of the wireless charging system, and to maintain a high intrinsic quality factor (Q) of the surface spiral coil at the operating frequency. Further details may be found in commonly owned PCT Patent Application Publication No. WO2020/069198, entitled “PARALLEL TUNED AMPLIFIERS,” which is incorporated by reference herein.

For some vehicle interior applications, a planar antenna or electrodeposited antenna may be an optimal alternative for minimizing cost, while a three-dimensional antenna may be an optimal selection for maximizing the intrinsic Q factor and the overall performance of the system. Some example intrinsic quality factors can be above 100 and sometimes even above 500 for vehicle embodiments. Furthermore, it may be desirable to use both a fabric-based antenna and other antenna types, such as planar, electrodeposited, and three-dimensional antennas, simultaneously. For example, it may be desirable to use a fabric-based antenna topology to meet the thin packaging requirements of the floor, while using a planar, surface spiral, or electrodeposited antenna for the receiver in the car seat, center console, infotainment system, or other vehicle interior product. This may be for easier manufacturing purposes for these product types, performance, cost, packaging, or other considerations.

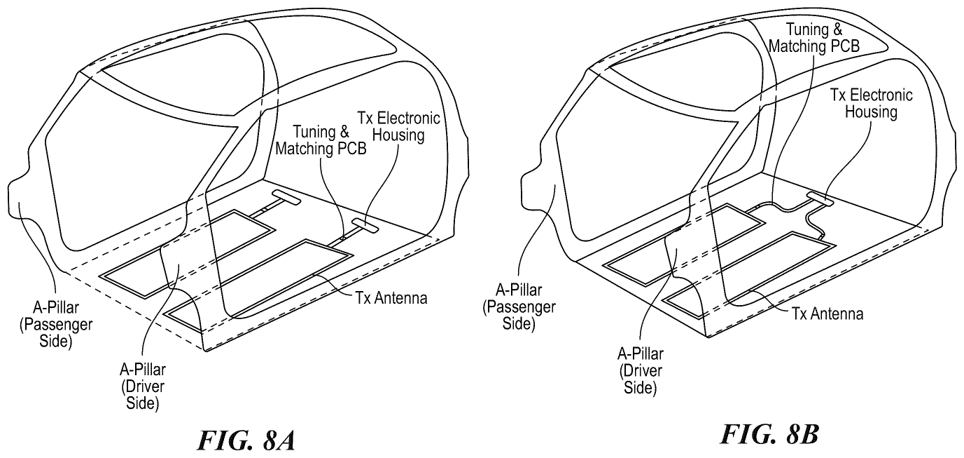

FIG. 8A and FIG. 8B depict an example wireless power vehicle interior system with (a) multiple tx antennas and (b) tx antennas driven by same electronics, respectively. FIG. 8A and FIG. 8B illustrate that there can be multiple transmitter fabric-based antennas operating in the same vehicle interior. This can be to focus the flux on certain areas of the vehicle rather than the entire interior. Alternatively, this can also be to better improve the performance of the transmitter antennas. The longer the antenna, the greater the coverage area for the vehicle receiver products. However, the increased length can result in higher resistances and lower intrinsic Q factors. This in turn can result in less coupling, lower system efficiency, and power received for the vehicle receiver products. Therefore, the length, width and number of transmitter fabric-based antennas can vary depending on the size of the vehicle interior, system efficiency, power, and cost requirements.

FIG. 8B shows that it is also possible to consolidate multiple transmitter fabric-based antennas to a single transmitter electronic housing unit. This can be to reduce the overall system cost, assuming that the transmitter electronics can meet the power requirements of all loads or vehicle products placed within the interior.

The following listing of solutions may be preferably implemented by some embodiments.
1. A vehicle interior product wireless power system, comprising: a transmitter electronic housing unit electrically connected to a wire harness of a vehicle, wherein the transmitter electronic housing unit comprises a switching amplifier, an impedance matching network, and/or one or more RF filters; a first tuning and matching PCB electrically connected to the transmitter electronic housing unit; a transmitter antenna electrically connected to the first tuning and matching PCB, a receiver antenna for capturing flux from the transmitter antenna; a second tuning and matching PCB electrically connected to the receiver antenna; and a receiver electronic housing unit electrically connected to the second tuning and matching PCB, wherein the receiver electronic housing unit is electrically connected to loads or vehicle functions embedded into a vehicle interior product, wherein the receiver electronic housing unit comprises an impedance matching network, an AC-DC converter and/or a DC-DC converter and/or a voltage regulation device that regulates output for the loads or the vehicle functions, wherein at least one antenna comprises a fabric-based antenna, comprising: a first support material layer; a second support material layer; and a base material layer disposed between the first support material layer and the second support material layer, wherein: the base material layer is a fabric-based conductor or conductive foil and less than several centimeters in thickness, and one or more feedline wires are electrically connected to conductive material of the base material layer.
2. The vehicle interior product wireless power system of solution 1, wherein the vehicle interior product being powered by the vehicle interior product wireless power system is one or many car seats, one or many center consoles, or one or many infotainment systems.
3. The vehicle interior product wireless power system of solutions 1-2, wherein tuning and matching components for the transmitter and/or receiver antennas are embedded into the antenna itself or directly embedded into the transmitter or receiver electronic housing units.
4. The vehicle interior product wireless power system of solutions 1-3, wherein the transmitter electronics include at least one of the following: a boost converter to increase the input voltage from the supply line to the amplifier, a step-down converter or regulator for the logic circuitry, reverse-polarity protection, EMI filters, fuse protection, other forms of EMI, short circuit, and/or reverse-polarity protection circuitry.
5. The vehicle interior product wireless power system of solutions 1-4, wherein components of the transmitter or receiver electronic housing units are incorporated into a single consolidated PCB.
6. The vehicle interior product wireless power system of solutions 1-5, wherein components of the transmitter or receiver electronic housing units are incorporated into separated PCBs within the transmitter or receiver electronic housing units.
7. The vehicle interior product wireless power system of solutions 1-6, wherein the transmitter or receiver electronic housing unit is partitioned into a single or several electronic housing modules for assembly.
8. The vehicle interior product wireless power system of solutions 1-7, wherein one or many transmitter and receiver antennas substantially resonate with capacitors at similar frequencies.
9. The vehicle interior product wireless power system of solution 8, wherein an optimal resonant frequency includes 85 kHz, 100 kHz, 6.78 MHz, 13.56 MHz, or 27.1 MHz.
10. The vehicle interior product wireless power system of solutions 1-9, wherein the base material layer comprises a fabric-based conductor or a conductive foil including copper foil, tin-plated copper foil, aluminum foil, aluminum polyester foil, copper polyester taffeta fabric, ripstop silver fabric, and/or Ni/Cu/Ag plated polyamide fabric.
11. The vehicle interior product wireless power system of solutions 1-10, wherein the first support material layer and/or the second support material layer comprises a low dissipation factor and dielectric constant plastic including ABS, polycarbonate, PLA, and/or polypropylene, or textile-based material including felt, denim, pellon, and/or polyester.
12. The vehicle interior product wireless power system of solutions 1-11, wherein a PCB with tuning and matching capacitors are embedded into one of support materials and electrically connected to feedlines of the fabric-based antenna to substantially excite the fabric-based antenna to resonate at an optimal resonant frequency of a target application.
13. The vehicle interior product wireless power system of solutions 1-12, wherein the loads or the vehicle functions embedded into the vehicle interior product comprise motor functions, electronic control unit (ECU) functions, SVS fans, heaters, multiple actuators, sound systems, infotainment systems, passenger devices, and/or speakers.
14. The vehicle interior product wireless power system of solutions 1-13, wherein the fabric-based antenna comprises: a first separation material layer disposed between the first support material layer and the base material layer; and/or a second separation material layer disposed between the base material layer and the second support material layer.
15. The vehicle interior product wireless power system of solutions 1-14, wherein the fabric-based antenna is embedded into a floor of a vehicle.
16. The vehicle interior product wireless power system of solutions 1-15, wherein a single transmitter fabric-based antenna powers one or many receiver antennas in a vehicle interior.
17. The vehicle interior product wireless power system of solutions 1-16, wherein a length and/or a width of the transmitter antenna is adapted based on a target application.
18. The vehicle interior product wireless power system of claims 1-17, wherein multiple transmitter fabric-based antennas are configured to operate in a vehicle interior to focus flux on one or more areas of the vehicle rather than an entirety of the vehicle interior and/or for improved performance from the multiple transmitter fabric-based antennas as compared to a single transmitter fabric-based antenna.
19. The vehicle interior product wireless power system of solutions 1-18, wherein the transmitter antenna and/or the receiver antenna comprises planar antennas, electrodeposited antennas formed directly onto a vehicle part, and/or three-dimensional antennas.

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

These and other changes can be made to the invention in light of the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A vehicle interior product wireless power system, comprising:
a transmitter electronic housing unit electrically connected to a wire harness of a vehicle, wherein the transmitter electronic housing unit comprises a switching amplifier, an impedance matching network, and/or one or more RF filters;
a first tuning and matching PCB electrically connected to the transmitter electronic housing unit;
a transmitter antenna electrically connected to the first tuning and matching PCB,
a receiver antenna for capturing flux from the transmitter antenna;
a second tuning and matching PCB electrically connected to the receiver antenna; and
a receiver electronic housing unit electrically connected to the second tuning and matching PCB, wherein the receiver electronic housing unit is electrically connected to loads or vehicle functions embedded into a vehicle interior product, wherein the receiver electronic housing unit comprises an impedance matching network, an AC-DC converter and/or a DC-DC converter and/or a voltage regulation device that regulates output for the loads or the vehicle functions,
wherein at least one antenna comprises a fabric-based antenna, comprising:
a first support material layer;
a second support material layer; and
a base material layer disposed between the first support material layer and the second support material layer, wherein:
the base material layer is a fabric-based conductor or conductive foil and less than several centimeters in thickness, and
one or more feedline wires are electrically connected to conductive material of the base material layer.

2. The vehicle interior product wireless power system of claim 1, wherein the vehicle interior product being powered by the vehicle interior product wireless power system is one or many car seats, one or many center consoles, or one or many infotainment systems.

3. The vehicle interior product wireless power system of claim 1, wherein tuning and matching components for the transmitter and/or receiver antennas are embedded into the antenna itself or directly embedded into the transmitter or receiver electronic housing units.

4. The vehicle interior product wireless power system of claim 1, wherein the transmitter electronics include at least one of: a boost converter to increase input voltage from a supply line to an amplifier, a step-down converter or regulator for a logic circuitry, reverse-polarity protection, EMI filters, fuse protection, other forms of EMI, short circuit, and/or reverse-polarity protection circuitry.

5. The vehicle interior product wireless power system of claim 1, wherein components of the transmitter or receiver electronic housing units are incorporated into a single consolidated PCB.

6. The vehicle interior product wireless power system of claim 1, wherein components of the transmitter or receiver electronic housing units are incorporated into separated PCBs within the transmitter or receiver electronic housing units.

7. The vehicle interior product wireless power system of claim 1, wherein the transmitter or receiver electronic housing unit is partitioned into a single or several electronic housing modules for assembly.

8. The vehicle interior product wireless power system of claim 1, wherein one or many transmitter and receiver antennas substantially resonate with capacitors at similar frequencies.

9. The vehicle interior product wireless power system of claim 8, wherein an optimal resonant frequency includes 85 kHz, 100 kHz, 6.78 MHz, 13.56 MHz, or 27.1 MHz.

10. The vehicle interior product wireless power system of claim 1, wherein the base material layer comprises a fabric-based conductor or a conductive foil including copper foil, tin-plated copper foil, aluminum foil, aluminum polyester foil, copper polyester taffeta fabric, ripstop silver fabric, and/or Ni/Cu/Ag plated polyamide fabric.

11. The vehicle interior product wireless power system of claim 1, wherein the first support material layer and/or the second support material layer comprises a low dissipation factor and dielectric constant plastic including ABS, polycarbonate, PLA, and/or polypropylene, or textile-based material including felt, denim, pellon, and/or polyester.

12. The vehicle interior product wireless power system of claim 1, wherein a PCB with tuning and matching capacitors are embedded into one of support materials and electrically connected to feedlines of the fabric-based antenna to substantially excite the fabric-based antenna to resonate at an optimal resonant frequency of a target application.

13. The vehicle interior product wireless power system of claim 1, wherein the loads or the vehicle functions embedded into the vehicle interior product comprise motor functions, electronic control unit (ECU) functions, SVS fans, heaters, multiple actuators, sound systems, infotainment systems, passenger devices, and/or speakers.

14. The vehicle interior product wireless power system of claim 1, wherein the fabric-based antenna comprises: a first separation material layer disposed between the first support material layer and the base material layer; and/or a second separation material layer disposed between the base material layer and the second support material layer.

15. The vehicle interior product wireless power system of claim 1, wherein the fabric-based antenna is embedded into a floor of a vehicle.

16. The vehicle interior product wireless power system of claim 1, wherein a single transmitter fabric-based antenna powers one or many receiver antennas in a vehicle interior.

17. The vehicle interior product wireless power system of claim 1, wherein a length and/or a width of the transmitter antenna is adapted based on a target application.

18. The vehicle interior product wireless power system of claim 1, wherein multiple transmitter fabric-based antennas are configured to operate in a vehicle interior to focus flux on one or more areas of the vehicle rather than an entirety of the vehicle interior and/or for improved performance from the multiple transmitter fabric-based antennas as compared to a single transmitter fabric-based antenna.

19. The vehicle interior product wireless power system of claim 1, wherein the transmitter antenna and/or the receiver antenna comprises planar antennas, electrodeposited antennas formed directly onto a vehicle part, and/or three-dimensional antennas.
